(19) United States
(12) Patent Application Publication
(10) Pub. No.: US 2004/0243494 A1
(43) Pub. Date: Dec. 2, 2004

(54) Financial transaction information capturing and indexing system

(75) Inventors: Robert Leland Jensen, San Antonio, TX (US); Daniel Victor Smith, San Antonio, TX (US)

Correspondence Address: Charles W. Hanor, 700 North St. Mary's Street, San Antonio, TX, 78205, US

(73) Assignee: Integrated Data Control, Inc.

(21) Appl. No.: 10/449,306

(22) Filed: May 28, 2003

(51) Int. Cl. G06F 17/60

(52) U.S. Cl. 705/35

(57) ABSTRACT

An information capturing system and method is provided for retrieving financial transaction information and related images from a financial institution web site. First, an account transaction history web page is accessed having a first set of links to processed financial transaction document images and a second set of links to an assortment of other objects. The first set of links is distinguished from the second set of links in order to automatically download the processed financial transaction document images without downloading the assortment of other objects. The method further comprises specifying a folder in which to download the processed financial transaction document images; saving the processed financial transaction document images into the specified folder; and generating or updating a searchable index of the contents of the specified folder.

### FIELD OF THE INVENTION

The invention relates generally to systems for organizing information, and more particularly, to a method and computer system for capturing, indexing, and perusing information.

### BACKGROUND OF THE INVENTION

The growth of the Internet has yielded innumerable advances in making a massive amount of information accessible and exchangeable. Nevertheless, there is a significant need for better system and software tools for capturing, organizing, and perusing such information.

For example, there is need for system and software tools for capturing, organizing, and perusing chat room information. This need is acutely felt by lawyers and law enforcement officials. It is well known, for example, that pedophiles often frequent chat rooms to seek out new victims. Therefore, for many years law enforcement agencies around the world have devoted resources to monitoring chat rooms to identify and apprehend suspected pedophiles. To date, however, these monitoring operations are excessively time-consuming and labor intensive.

Chat room clients typically store the chat stream in a volatile, limited-size memory buffer. When the buffer is full, old chat information is deleted to make room for new information as it is added. In order to make a permanent record of the contents of a chat room, a law enforcement agency will typically have a staff person periodically right-click a computer mouse inside a chat stream frame and select the print option. Later, a law enforcement official will skim through potentially thousands of printed pages of chat room text looking for conversation that may identify a potential pedophile. Needless to say, there is a substantial need for a more efficient method of recording chat room content. There is also a need for a more efficient method of perusing chat room content.

There is also a need for system and software tools for capturing, organizing, and perusing financial transaction information, especially check images. Financial institutions such as banks, credit unions, and saving and loan institutions spend massive amounts of money to store or scan and archive images of the billions of cancelled checks, deposit slips, and other financial documents that they process every year. Some of these institutions mail copies of cancelled checks to their customers at great expense. To reduce those expenses, others make their customers' account information, including check and deposit slip images, available to their customers online.

The customers of these financial institutions, however, have no efficient way of making a permanent record and searchable archive of the cancelled check or deposit slip images. Instead, such customers are typically required to open each check image individually, one at a time, and print or locally save the check image. For high-transaction-volume customers, this is an exceedingly time-consuming exercise. Needless to say, there is a substantial need for an efficient method of making a permanent and searchable database of a customer's check and deposit slip images.

There is also a need for a system and software tools for capturing, organizing, and perusing groups of linked web pages. Currently, the most popular Internet browser has a “save” feature operable to save the web page displayed in the browser and any embedded frames or graphics that are also displayed in the browser. That browser is not, however, operable to simultaneously save the set of web pages to which the displayed web page is linked. Nor is it operable to simultaneously save the remotely linked web pages to the displayed web page. Furthermore, this popular browser does not generate a searchable index of the saved group of web pages.

There is also a need for a system and software tools for authenticating downloaded web pages. For example, in litigation evidence in the form of web pages is often introduced into trial. Because the content of a saved web page is easily manipulable, there is a need for a mechanism to verify the integrity of a file that was saved at a specific time and date.

### SUMMARY OF THE INVENTION

This invention is directed to, but not limited by, one or more of the following objects, separately or in combination:

capturing information, including information from the Internet;

indexing and organizing captured information;

capturing and indexing discrete periodic time-stamped records of chat room content;

capturing and indexing financial transaction information, including check images;

creating a system to automatically and periodically save and index a specified web page to a folder or database;

simultaneously saving and indexing web pages and the files to which they are linked;

simultaneously saving and indexing remotely linked web pages residing on a common web site;

generating authentication information to incorporate into an indexed file; and

authenticating indexed files to detect possible alterations or a compromise of file or date and time stamp integrity.

Therefore, one embodiment of an information capturing system is provided comprising a chat stream capturing module that enables chat stream data to be automatically and periodically extracted from a chat room hosted on a computer network and the chat stream data stored to one or more files. The information capturing system further comprises an index module that enables generation of a searchable index of the one or more files; a search module that enables a search to be performed of the index according to a search criterion to locate words and phrases in the one or more files; and a graphical user interface module with a browser window that enables the chat room to be displayed to a user. The graphical user interface module also has a mode that provides a folder view pane adjacent to a file view pane, the folder view pane being operable to display a listing of the one or more files and operable to enable a user to select one of the one or more files, the file view pane enabling display of any file selected in the folder view pane. The information capturing system further comprises an interface enabling user specification of a folder in which to save the one or more files storing the chat stream data. The interface also enables user specification of a frequency with which to save the chat stream data to the one or more files. The chat stream capturing module is operable to identify a date and time when the chat stream data stored in the one or more files was extracted and the chat stream capturing module is further operable to generate names for each of the one or more files that incorporate the identified date and time.

Another embodiment of an information capturing and indexing system is provided comprising a chat stream capturing module that enables contiguous time-delimited segments of chat stream data to be automatically and serially extracted from a chat room hosted on a computer network and the segments stored to a plurality of files, each file storing only a single time-delimited segment of chat stream data; an index module that enables generation of a searchable index of the plurality of files; and a search module that enables a search to be performed of the index according to a search criterion to locate words and phrases in the plurality of files. The chat stream capturing module is operable to identify a date and time when the chat stream data stored in the one or more files was extracted. The chat stream capturing module is further operable to generate names for each of the one or more files that incorporate the identified date and time. The information capturing and indexing system further comprises a file authentication module operable to generate and insert authentication codes into each of the plurality of files, each authentication code being at least partly derived from one or more attributes of each file, the file authentication module being further operable to compare the authentication codes with the one or more attributes of each file to detect whether the file is compromised. The information capturing and indexing system further comprises a database and file selection module operable to display the plurality of files.

Also provided is a method of recording chat stream data from a chat stream frame embedded in a chat room web page hosted on a computer network, the method comprising identifying the chat room web page; automatically locating the chat stream frame on the chat room web page, the chat stream frame containing the chat stream data; and automatically extracting at least a portion of the chat stream data to a file. One embodiment of the extraction step comprises serially extracting contiguous time-delimited segments of the chat stream data to a plurality of files, each file storing only a single time-delimited segment of chat stream data. The method further comprises specifying the duration of each time-delimited segment; identifying a date and time when the chat stream data stored in the plurality of files was extracted; generating names for each of the plurality of files that incorporate the identified date and time; specifying the folder in which to save the chat stream data; saving the plurality of files to a folder; and generating a searchable index of the chat stream data.

Also provided is an information capturing system for retrieving financial transaction information. The system comprises a browser module operable to link to a web page containing an account transaction history web page, the account transaction history web page having a first set of links to processed financial transaction document images, and a second set of links to an assortment of other objects; and a financial transaction image capture module operatively linked to the browser module, the image capture module being operable to evaluate the account transaction history web page, distinguish the first set of links from the second set of links, and automatically download the processed financial transaction document images without downloading the assortment of other objects. The processed financial transaction documents may include cancelled checks.

One embodiment of the information capturing system further comprises a dialog box operable to enable a user to identify a folder into which the financial transaction image capture module saves the processed financial transaction documents images; an index generating module operable to generate a searchable index of the account transaction history web page and the processed financial transaction documents images; and a database and file selection module operable to display the specified folder and any contents that have been saved to the specified folder.

Also provided is a method for retrieving financial transaction information. The method comprises accessing a web page containing an account transaction history web page, the account transaction history web page having a first set of links to processed financial transaction document images, and a second set of links to an assortment of other objects; automatically distinguishing the first set of links from the second set of links; and automatically downloading the processed financial transaction document images without downloading the assortment of other objects. The method may further comprise specifying a folder in which to download the processed financial transaction document images; saving the processed financial transaction document images into the specified folder; downloading the account transaction history web page; saving the downloaded account transaction history web page into the specified folder; modifying the first set of links in the downloaded account transaction history web page to link to the saved processed financial transaction document images; and generating or updating a searchable index of the contents of the specified folder.

Another embodiment of an information capturing system is provided for retrieving financial transaction information. This system comprises means for linking to a web page containing an account transaction history web page, the account transaction history web page having a first set of links to processed financial transaction document images, and a second set of links to an assortment of other objects; and means for automatically evaluating the account transaction history web page, distinguishing the first set of links from the second set of links, and downloading the processed financial transaction document images without downloading the assortment of other objects. The information capturing system further comprises indexing means for generating a searchable index of the account transaction history web page and the processed financial transaction documents images; means for enabling a user to specify a folder into which the processed financial transaction documents images are to be saved; and means for displaying the contents of the specified folder.

Another embodiment of an information capturing and indexing system is provided comprising a database selection module that enables selection of a plurality of files for inclusion into at least one selectable database and that further enables individual selection of any of the plurality of files after they have been included into the at least one selectable database; an authentication module operable to generate and insert authentication codes into each of the plurality of files, the authentication module being further operable to compare the authentication code in an individually selected one of the plurality of files with one or more attributes of the individually selected file to detect whether the individually selected file is compromised; and an index module that enables generation of a searchable index of the plurality of files. The information capturing and indexing system may further comprise a search module that enables a search to be performed of the index according to a search criterion to locate words and phrases in the plurality of files.

The authentication module is further operable to determine a date and time during which any file is selected for inclusion into a selectable database and generate a time stamp derived from said date and time. The authentication module is further operable to generate the time stamp from a cryptographic transformation function having an input and an output, wherein the date and time is supplied as the input and the time stamp is derived from the output.

Also provided is a method of capturing and indexing a digital file comprising a plurality of bits of information, the method comprising obtaining data about the digital file; providing the data as an input to a cryptographic transformation function; generating an authentication code comprising an output of the cryptographic transformation function; inserting the authentication code into the file; saving the file to a computer-readable medium; and indexing the file.

In one embodiment, the step of generating an authentication code itself comprises the steps of rendering the digital file as a two-dimensional matrix having a plurality of rows and columns that define a plurality of cells, wherein each cell of the matrix comprises one of the file's bits and substantially all of the file's bits are represented in the matrix; for each column in the matrix, computing a columnar sum equal to the sum of the bits in the cells of the column; multiplying each columnar sum by a unique multiplier; and computing a message digest equal to the sum of the products of each columnar sum and its corresponding multiplier.

In another embodiment, the step of generating an authentication code comprises the steps of estimating the date and time during which the step of saving the file to a computer-readable medium is to be performed; providing the estimated date and time as an input to the cryptographic transformation function; generating a time stamp that comprises an output of the cryptographic transformation function; and incorporating the time stamp into the authentication code.

Also provided is a method of authenticating a digital file stored on a computer-readable medium, wherein the digital file comprises a first set of bits and a second set of bits, wherein the second set of bits represents encrypted information about the digital file, the method comprising obtaining data about the digital file; providing the data as an input to a cryptographic transformation function; generating an authentication code comprising an output of the cryptographic transformation function; comparing the authentication code with the encrypted information represented in the second set of bits; authenticating the digital file if the authentication code matches the encrypted information represented by the second set of bits; and generating a warning if the authentication code does not match the encrypted information represented by the second set of bits.

In one embodiment, the data obtained in the step of obtaining data about the digital file is a date and time during which the digital file was last saved to the computer-readable medium. In another embodiment, the data obtained in the step of obtaining data about the digital file comprises the first set of bits. In the latter embodiment, the step of generating an authentication code comprises the steps of rendering the first set of bits as a two-dimensional matrix having a plurality of rows and columns that define a plurality of cells, wherein each cell of the matrix comprises a unique bit from the first set of bits and all of the bits of the first set of bits are represented in the matrix; for each column in the matrix, computing a columnar sum equal to the sum of the bits in the cells of the column; multiplying each columnar sum by a unique multiplier; and computing a message digest equal to the sum of the products of each columnar sum and its corresponding multiplier.

These and other objects, features, and advantages of the present invention will be readily apparent to those skilled in the art from the following detailed description taken in conjunction with the annexed sheets of drawings, which illustrate the invention.

### BRIEF DESCRIPTION OF THE DRAWINGS

FIG. 1 is a block diagram of a computer system and network for use with an information capturing and indexing system.

FIG. 2 is a block diagram of one embodiment of an information capturing and indexing system.

FIG. 3 is a screen display illustrating the multi-frame architecture of a typical Internet-based chat room interface with a browser-view embodiment of the graphical user interface (GUI) display module of FIG. 2.

FIG. 4 is a block diagram illustrating a typical chat room web page comprising a top level page and one or more linked embedded frame pages.

FIG. 5 is a flow diagram of one embodiment of a method of capturing and indexing chat stream content.

FIG. 6 is a pictorial diagram illustrating the frame location, periodic saving, and indexing functions of one embodiment of a system of insuring and indexing chat stream content.

FIG. 7 is a screen display of a folder selection dialog box of one embodiment of a system for capturing and indexing chat stream content.

FIG. 8 is a screen display of a folder view embodiment of the GUI display module of FIG. 2 displaying saved chat stream content.

FIG. 9 is a screen display of a hypothetical web page providing links to a financial customer's check images, displayed within the browser embodiment of the GUI display module of FIG. 2.

FIG. 10 is a screen display of a portion of the hypertext markup language (HTML) code constituting the web page of FIG. 9.

FIG. 11 is a functional flow diagram of one embodiment of a method of capturing and indexing account information and financial transaction images.

FIG. 12 is a pictorial diagram illustrating various functions of one embodiment of a system for capturing and indexing account information and financial transaction images.

FIG. 13 is a screen display of a folder selection dialog box of one embodiment of a system for capturing and indexing financial transaction information and images.

FIG. 14 is a screen display of a folder view embodiment of the GUI display module of FIG. 2 displaying saved account info.

FIG. 15 is a blocked diagram of one embodiment of a system for periodically saving and indexing one or more web pages.

FIG. 16 is a screen display of a scheduling dialog box of one embodiment of a system for periodically saving and indexing one or more web pages.

FIG. 17 is a screen display of a typical operating system task scheduler, listing two exemplary tasks added by the system of FIG. 16.

FIG. 18 is a screen display of a folder view embodiment of the GUI display module of FIG. 2, displaying an exemplary page saved at an exemplary time by the system of FIG. 16.

FIG. 19 is a functional flow chart of one embodiment of a method of periodically saving and indexing one or more web pages.

FIG. 20 is a block diagram showing the linking relationships between an exemplary group of web pages residing on and external to a web site.

FIG. 21 is a block diagram illustrating one embodiment of a method of saving a web page and all the pages to which it is linked.

FIG. 22 is a block diagram illustrating one embodiment of a method of saving all of the linked web pages residing on a common web site.

FIG. 23 is a screen display of a folder view embodiment of the GUI display module of FIG. 2 showing a folder pane listing the pages saved by performing the method of FIG. 21 on the exemplary group of web pages depicted in FIG. 20.

FIG. 24 is a screen display of a folder view embodiment of the GUI display module of FIG. 2 showing a folder pane listing the pages saved by performing the method of FIG. 22 on the exemplary group of web pages depicted in FIG. 20.

FIG. 25 is a pictorial diagram of various functions of one embodiment of a system to authenticate an indexed file.

FIG. 26 is a functional block diagram of a method of adding authentication information to a file.

FIG. 27 is a functional flow diagram of a method of authenticating an indexed file.

FIG. 28 illustrates a portion of the HTML code of an exemplary web page containing an authentication-related meta tag.

FIG. 29 is a screen display of a dialog box presented by one embodiment of a system for authenticating an index file when a page that has been altered is selected in the folder view embodiment of the GUI display module of FIG. 2.

### DETAILED DESCRIPTION

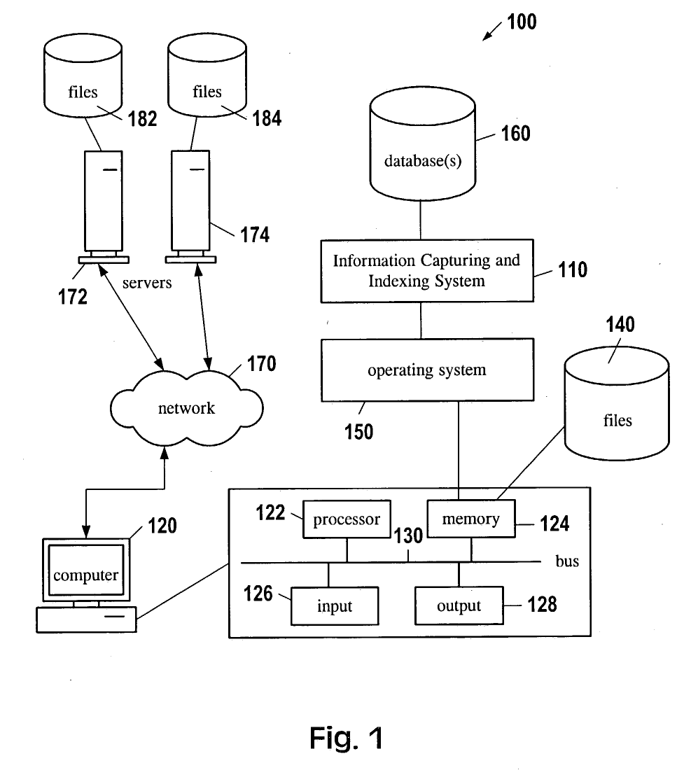

FIG. 1 is a block diagram of a computer system and network 100 for use with an information capturing and indexing system 110. The information capturing and indexing system 110 and a computer operating system 150 reside on the memory 124 of a computer 120. The memory 124 of the computer 120 may comprise but is not limited to any combination of the following: volatile random-access memory, flash memory, hard drives, floppy drives, compact disk drives, optical drives, connected to and accessible to the processor 122. The computer 120 stores a collection of electronically accessible files 140 within the memory 124. Among these files 140 are databases or folders 160 which the information capturing and indexing system 110 uses to organize and index various information, as described-in our co-pending U.S. patent application Ser. No. 09/257,714.

The computer 120 also has a processor 122, bus 130, input devices 126, and output devices 128. The input devices 126 may include, but are not limited to, familiar devices such as computer mice, keyboards, scanners, communication ports, and touch screens. The output devices 128 may include, but are not limited to, familiar devices such as computer monitors, speakers, printers, communication ports, and other peripherals. Computer 120 is preferably linked via a network 170 to a plurality of servers 172 and 174, each of which provides access to various groups of files 182 and 184.

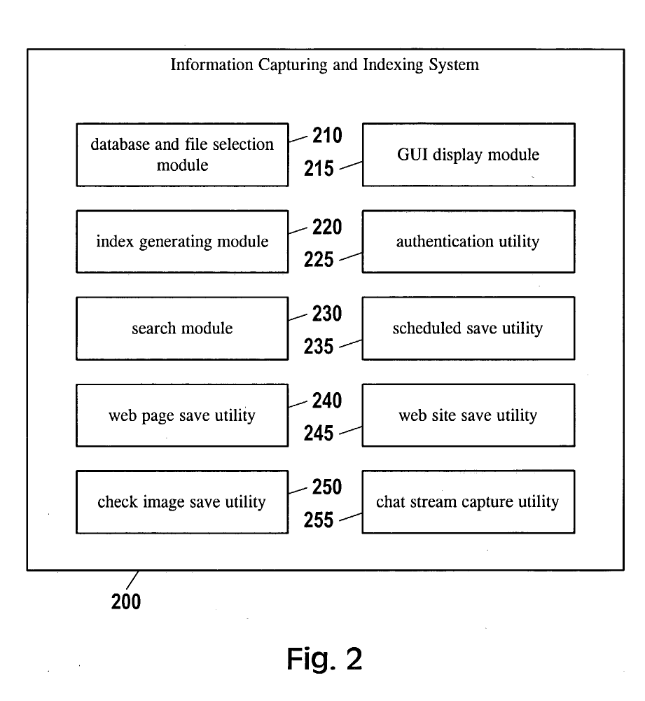

FIG. 2 is a block diagram of one embodiment of an information capturing and indexing system 200. The system 200 is operable to perform a number of separately identifiable functions, and therefore it is illustrated as having a plurality of operational modules, including a database and file selection module 210, a graphical user interface (GUI) display module 215, an index-generating module 220, a file authentication utility or module 225, a search module 230, a scheduled save utility 235, a web page save and index utility 240, a web site save and index utility 245, a check image save utility 250, and a chat stream capture utility 255.

One or more embodiments of the database and file selection module 210 are described in our co-pending patent application for “A Database System and Method for Data Acquisition and Perusal” filed on Feb. 25, 1999, having Ser. No. 09/257,714, which application is herein incorporated by reference. That application also describes one or more embodiments of the GUI display module 215, the index-generating module 220, and the search module 230. Further embodiments of the GUI display module 215 are depicted and described in this application.

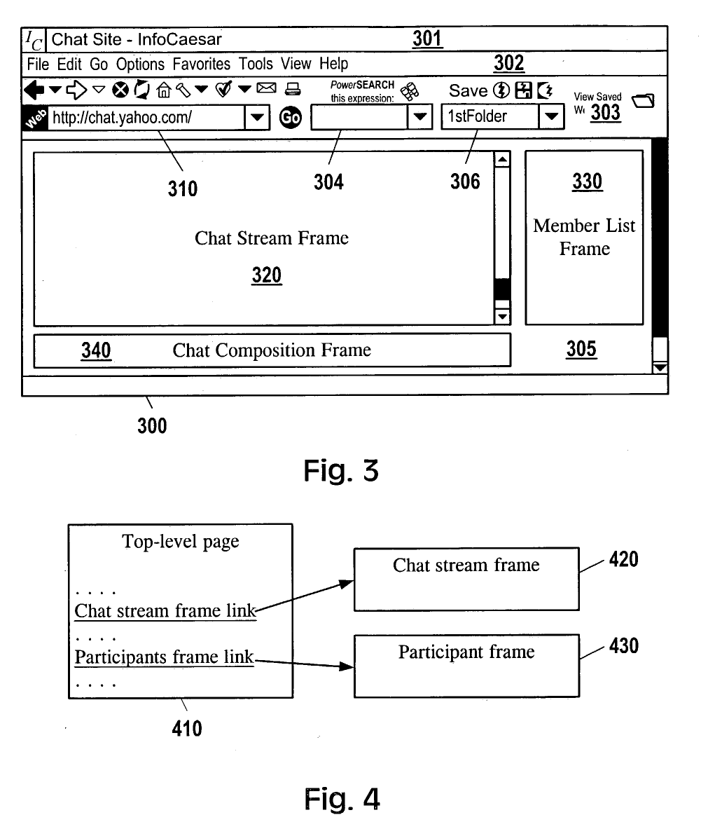

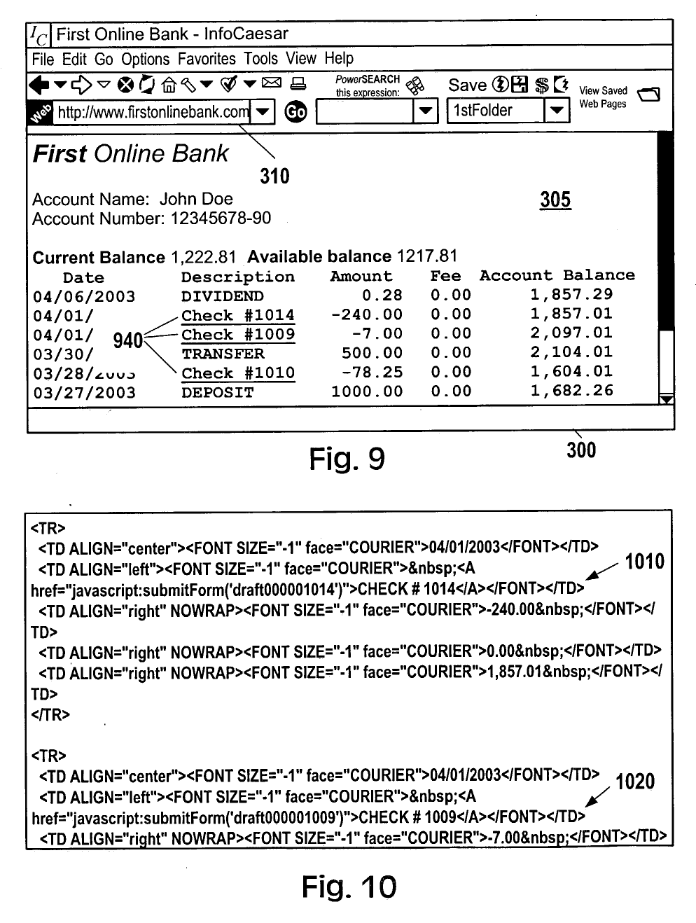

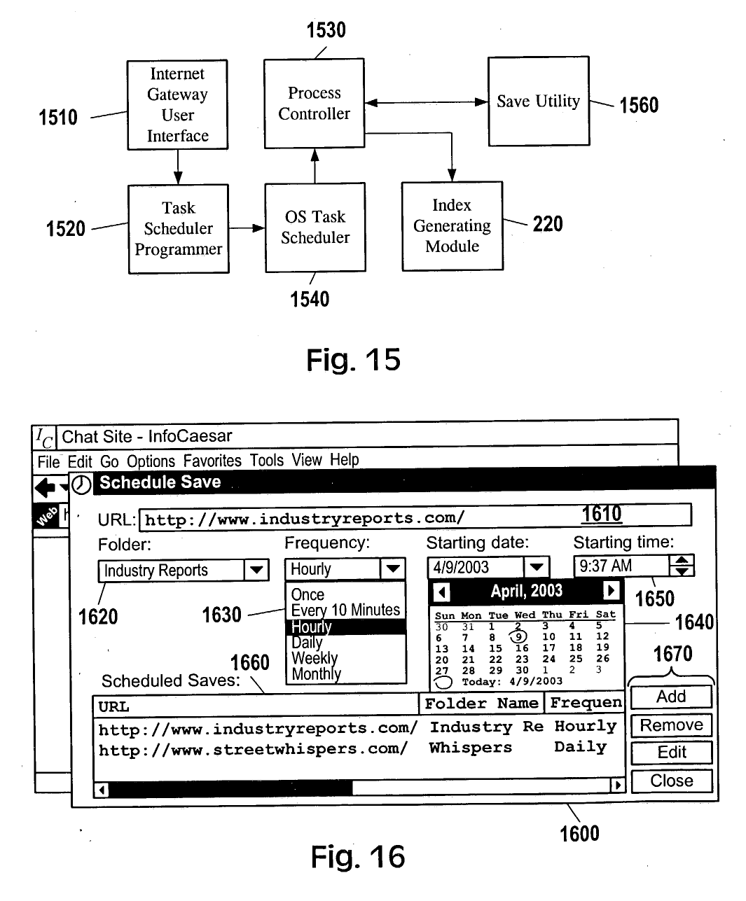

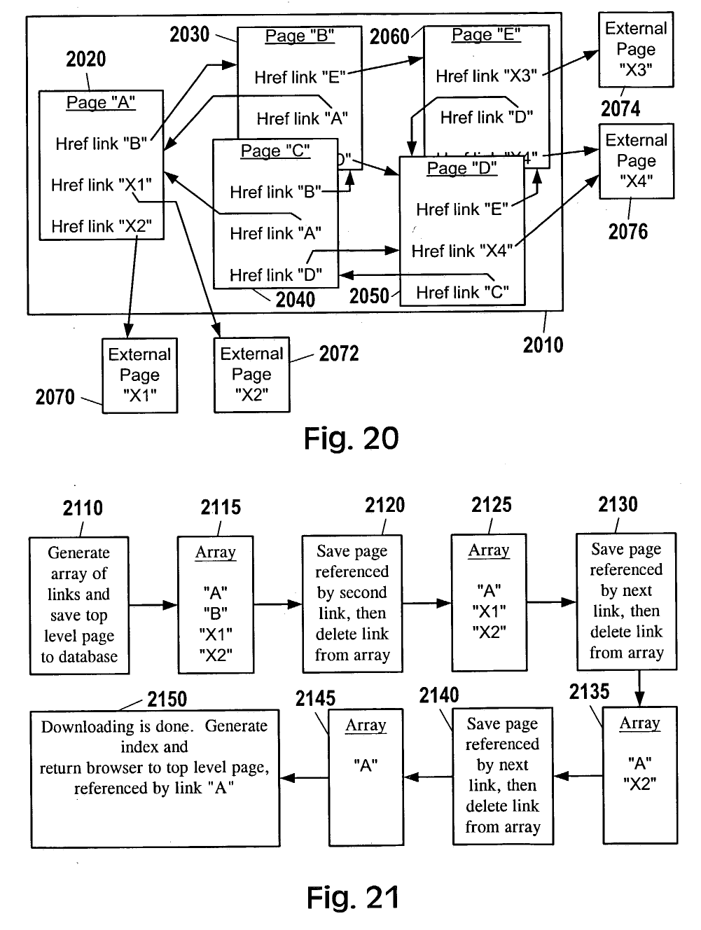

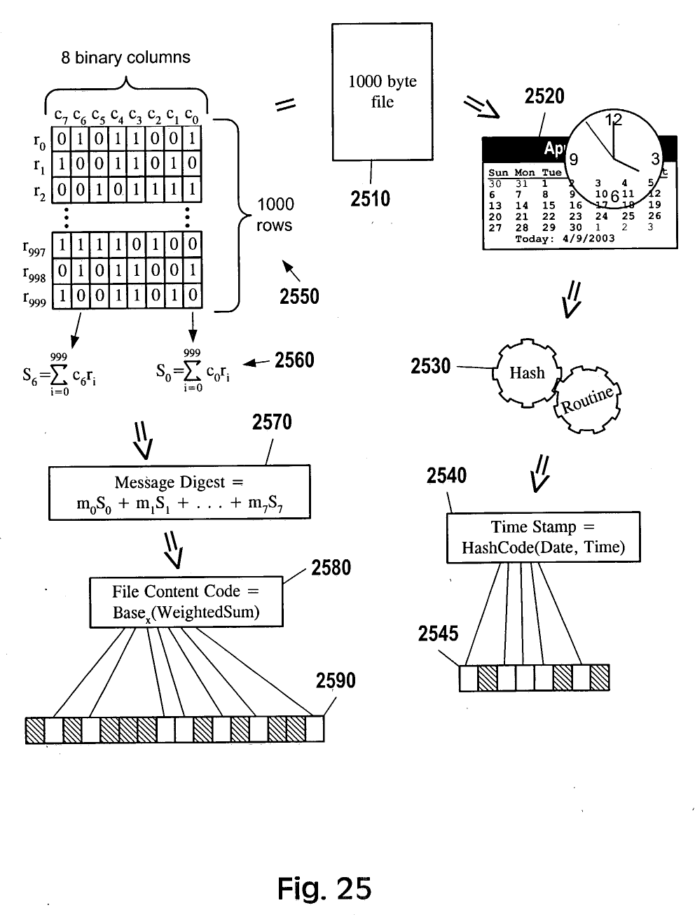

One or more embodiments of a chat stream capture utility 255 are displayed and described herein in connection with FIGS. 3-8. One or more embodiments of the check image save utility 250 are in connection with FIGS. 9-14. One or more embodiments of the scheduled save utility 235 are described in connection with FIGS. 15-19. One or more embodiments of the web page save utility 240 and web site save utility 245 are described in connection with FIGS. 20-24. And several embodiments of the authentication utility 225 are described further below in connection with FIGS. 25-29.

The invention described herein should be understood to embrace, but not necessarily be limited to, an information capturing and indexing system 200 that includes all or any novel and nonobvious subcombination of the operational modules or utilities 210-255 described herein. Those of ordinary skill in the art will, with the aid of the disclosure contained herein, understand how to draft software code to carry out the disclosed functions.

### Chat Stream Capture

As noted above, FIGS. 3-8 illustrate the chat stream capturing functionality and operability of the present invention. As used in this application, the phrase “chat room” refers to any forum that utilizes the Internet to facilitate real-time typed conversations between two or more participants. In a typical chat room, the messages that a participant enters or types are shown instantly to every other member of the room. Consistently, the references to “chat” and “chat stream” in this application refer to the typed communications posted by the participants on the forum.

FIG. 3 is a screen display illustrating the multi-frame display architecture of a typical Internet-based chat room client hosted within a browser view embodiment 300 of the GUI display module 215 of FIG. 2. The browser view embodiment 300 provides a title bar 301, a menu bar 302, a button bar 303, an address bar 310, a search bar 304, a save folder bar 306, and a browser window 305 for displaying the contents of a file or page located at an address specified within the address bar 310.

As seen in FIG. 3, the browser window 305 depicts a web page having a multi-frame architecture, including a chat stream frame 320, a member list frame 330, and a chat composition frame 340. In the background it was noted that chat room clients typically store chat streams in a volatile memory buffer. In this example, the chat stream frame 320 would display the chat stream contents of the volatile memory buffer of the chat room client. FIG. 4 further illustrates the multi-frame architecture of a typical chat room page, showing a top level page 410 having links to a chat stream frame 420 and participant frame 430, both of which are displayed in the browser window 305 as embedded frames.

In a preferred embodiment, the present invention captures chat stream content by automatically locating the frame 320 containing the chat stream and saving discrete time-interval portions of the chat stream into discrete files. The present invention then generates a searchable index of the files. FIG. 6 is a pictorial diagram illustrating this preferred approach. Block 610 depicts a chat room web page 610 with several embedded objects and frames, including one object or frame 625 displaying the chat stream content. A magnifying glass 620 is depicted over the object 625, illustrating the function of locating the embedded frame 625 containing the chat stream. Block 630 illustrates the preferred process of capturing the chat stream. The spigot 635 on the chat stream object 625 illustrates the process of extracting time-delimited blocks of chat stream text from the chat stream object 625. The conveyor belt 640 illustrates the process of saving these time-delimited blocks of chat stream text to individual time-interval files 642, 644, and 646. Finally, block 650 depicts a searchable index generated of the files 642, 644, and 646.

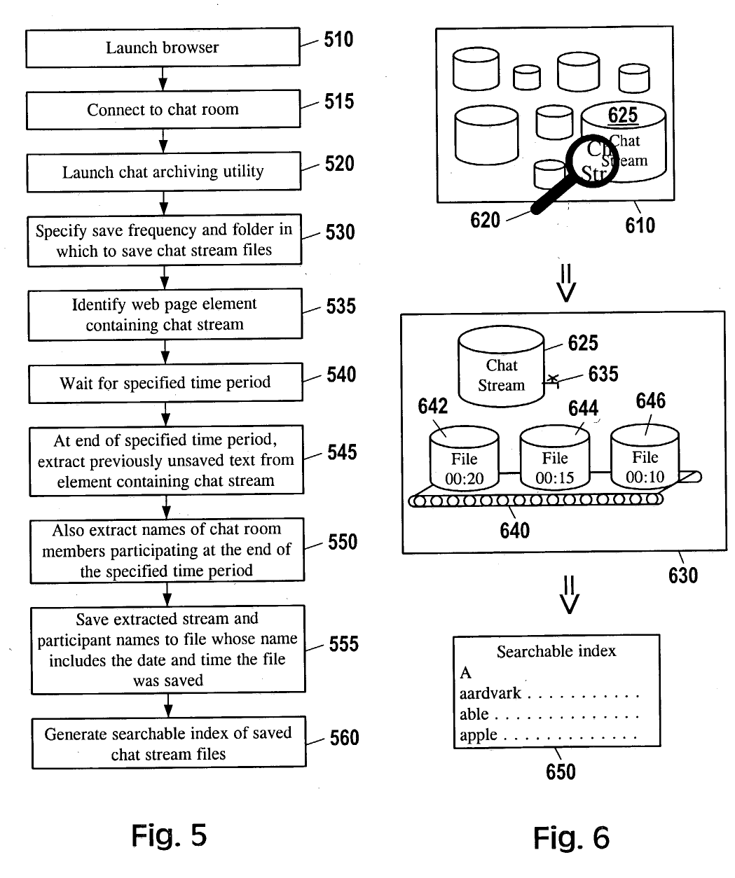

FIG. 5 is a flow diagram of one embodiment of a method of capturing and indexing the chat stream content. In functional block 510, a user of the information capturing and indexing system 200 launches a browser embodiment of the GUI display module 215. In functional block 515, the user connects the browser to an on-line chat room. In functional block 520, the user launches the chat stream capture utility or module 255 of the information capturing and indexing system 200. In functional block 530, the user specifies the frequency with which to save the chat stream into separate files and the folder or database into which to save those chat stream files. It will of course be understood that a batch process or other automated process may substitute for the functions carried out by the user in functional blocks 510 through 530. Of course, such an automated process would not necessarily need to launch the GUI display module 215.

Now that the chat room, save frequency, and database in which to save the chat stream have all been identified, the chat stream capture utility 255 identifies the web page element or frame containing the chat stream, as depicted in functional block 535. In functional block 540, the chat stream capture utility 255 allows chat stream content to accumulate for the specified time period. In functional block 545, at the end of the specified time period, the chat stream capture utility 255 extracts previously unsaved chat stream content from the element or frame containing the chat stream. To distinguish previously saved from previously unsaved chat stream content, the chat stream capture utility 255 preferably remembers the last two lines of chat stream content saved in the most recent file saved (if any) as a bookmark. This bookmark delimits and distinguishes previously saved chat stream text from text that has been added since the last stream segment was saved.

In functional block 550, the chat stream capture utility 255 identifies the names of chat room members participating at the end of a given time interval. In functional block 555, the chat stream capture utility 255 saves the extracted stream and participant names to a file. A name for the file is generated that includes the date and the time the file was saved. In functional block 560, the index generating module 220 of the information capturing and indexing system 200 generates a searchable index of saved chat stream files using indexing techniques described in our co-pending patent application Ser. No. 09/257,714.

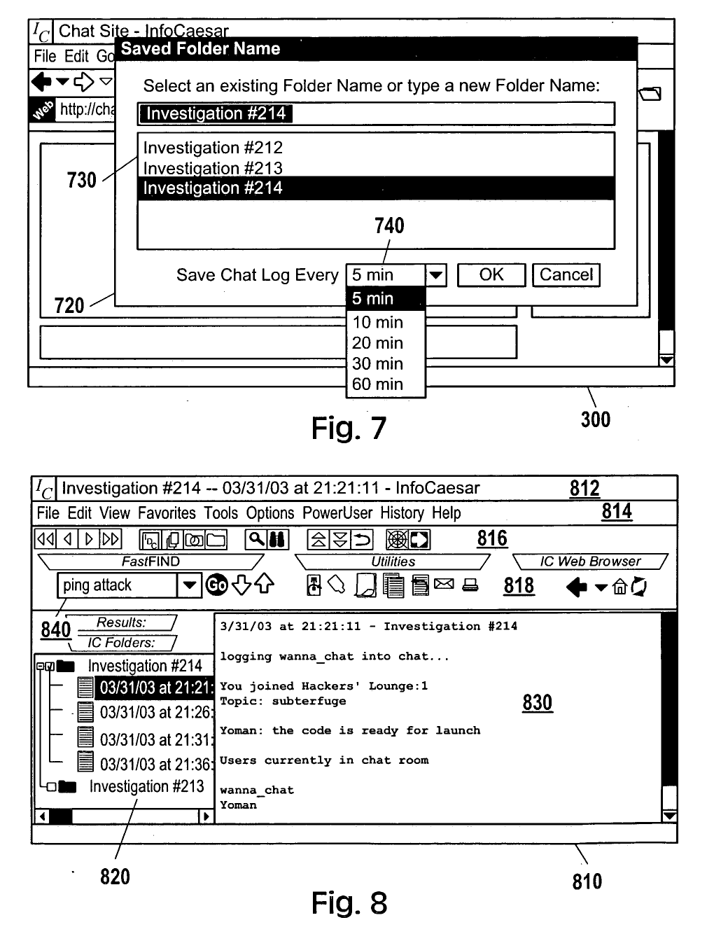

FIG. 7 is a screen display of a folder selection dialog box 720 of one embodiment of a system for capturing and indexing chat stream content. The folder selection dialog box 720 is depicted as being superimposed on the browser view embodiment 300 of the GUI display module 215 of FIG. 2. Folder selection dialog box 720 includes a list 730 of existing folders or databases registered with the information capturing and indexing system 200. The folder selection dialog box 720 also provides a time interval menu 740, through which a user can select the frequency with which chat stream content should be saved. Short time intervals are preferred for chat rooms having an exceptional amount of participation or containing relatively small volatile memory buffers for holding the chat stream content.

FIG. 8 is a screen display of a folder view embodiment 810 of the GUI display module 215 of FIG. 2, illustrating exemplary chat stream content saved and indexed by the systems depicted in the preceding figures. Folder view embodiment 810 provides a title bar 812, a menu bar 814, button bars 816 and 818, and a search bar 840 for searching for words and phrases in indexed files. The folder view embodiment 810 also provides a folder view pane 820 to enable a user to select a folder and specific file. The folder view embodiment 810 also provides a file view pane 830 to display the file specified in the folder view pane 820.

### Check Image Capture

As noted above, FIG. 9-14 illustrate the check image capturing functionality and operability of the present invention. FIG. 9 is a screen display of a hypothetical web page providing links to a financial customer's check images, displayed within the browser embodiment 300 of the GUI display module 215 of FIG. 2. The address bar 310 identifies the web site of a hypothetical financial institution. The browser window 305 displays the recent financial transaction history of a customer's account, including links 940 to the customer's canceled check images. FIG. 10 illustrates a portion of the HTML code constituting the web page displayed in the browser window 305 of FIG. 9. Lines 1010 and 1020 depict the code used to access the cancelled check images to which two of the links 940 refer.

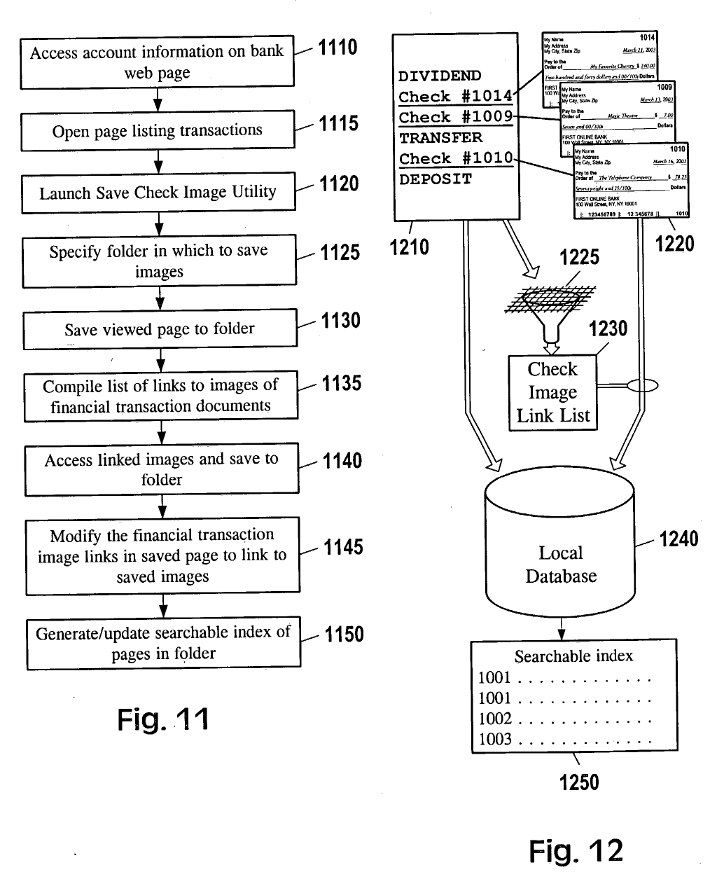

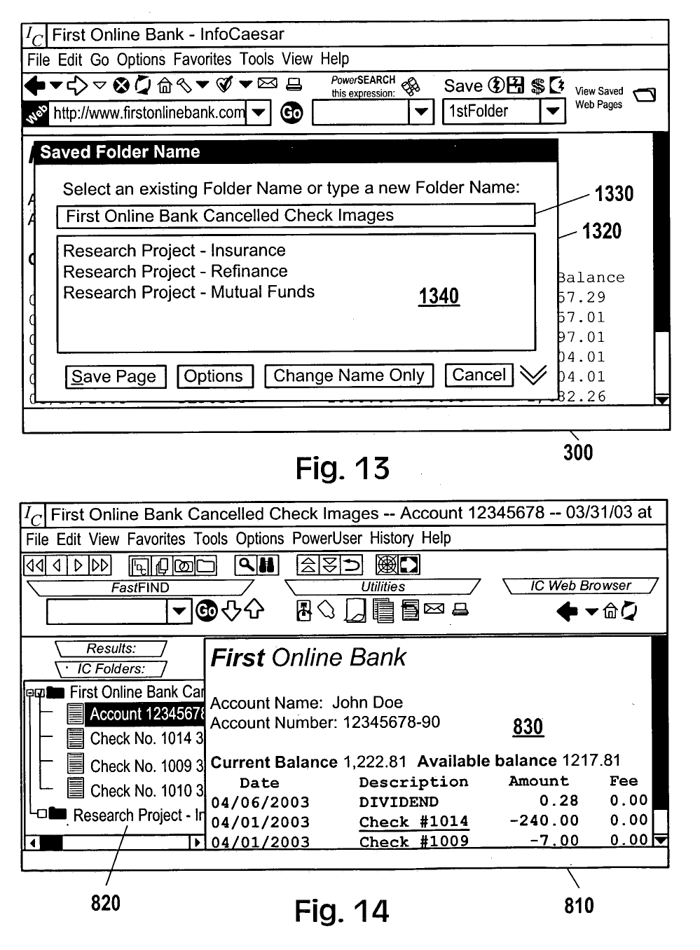

FIG. 11 is a functional flow diagram of one embodiment of a method of capturing and indexing account information and financial transaction images. In functional block 1110, the user accesses account information on a financial institution web site. It will be understood that with the technology most prevalent today, a user is typically required to enter a user name and password to access such information. In functional block 1115, the user opens a web page listing his or her most recent financial transactions and providing links to images of financial transaction documents such as canceled checks, deposit slips, and the like. In functional block 1120, the user launches the check image saving utility 250 of the information capturing and indexing system. In functional block 1125, the user specifies a folder in which to save the check images as well as the account information. A dialog box for specifying the folder is illustrated in FIG. 13, which is described in more detail below.

In functional block 1130, the check image save utility 250 (FIG. 2) saves the viewed page to the folder specified in functional block 1125. In functional block 1135, the check image save utility 250 compiles a list of links to images of financial transaction documents such as canceled checks, deposit slips, and the like. In a preferred embodiment, the check image save utility 250 identifies these links using predetermined knowledge of how the financial institution identifies these links in its web pages. In this preferred embodiment, the check image save utility 250 will typically be customized for a specific financial institution. This provides financial institutions with an opportunity to provide information capturing and indexing system 200 software that is capable of automated check image capture functionality solely from the financial institution's web site. Alternatively, persons of ordinary skill in the art will understand how to modify the check image save utility 250 to look for a standardized tag or other standardized identifying information that distinguishes financial transaction image links from links to other types of information.

In functional block 1140, the check image save utility 250 accesses the linked images and saves them to the specified folder. In some financial institution web sites, a linked image is accessed through a pop-up window that is spawned to display the check. In such web sites, saving the image may require a new navigation to the page displaying the image. However, the web site's security system may only allow access to a check image from a logged-in browser window. To overcome this obstacle, the check image save utility 250 reforms the link so the new navigation is through the already logged-in browser window, thus making the navigation fall under the existing security login.

In functional block 1145, the check image save utility 250 modifies the financial transaction image links in the saved account information page so that they link to the locally saved financial transaction images. In functional block 1150, the information capturing and indexing system 200 generates or updates a searchable index of the financial transaction account information pages and images in the specified folder.

It will be understood that the user-controlled operations depicted in blocks 1115 through 1125 could optionally be automated using a batch program or other computer automated routine. Moreover, it should be understood that the invention is not necessarily limited to the order in which these functions are performed, or to methods that perform fewer than all of the illustrated functions.

FIG. 12 is a pictorial diagram illustrating various aspects of one embodiment of a system and method of capturing and indexing account information and financial transaction images. The top left portion of FIG. 12 depicts a portion of an account information web page 1210 displaying links to assorted financial transaction images 1220. A software filter 1225 evaluates the various links embedded in the account information web page 1210 and generates a list 1230 of the links to the assorted financial transaction images 1220. The account information web page 1210 and the linked financial transaction images 1220 are saved to a local database 1240. Also, a searchable index 1250 of the account information web page 1210 and financial transaction images 1220 is generated.

FIG. 13 is a screen display of one embodiment of a folder selection dialog box 1320 that is prompted by the check image save utility 250 (FIG. 2) when a user launches the utility 250. As shown in FIG. 13, the dialog box 1320 is superimposed upon the browser embodiment 300 of the GUI display module 215 of the information capturing and indexing system 200. The dialog box 1320 provides a folder name specification bar 1330 and a list 1340 of existing folders.

FIG. 14 is a screen display of the folder view embodiment 810 of the GUI display module 215 in FIG. 2. The folder view pane 820 lists a group of files saved in a folder entitled “First Online Bank Canceled Check Images.” Of the listed files, the index file entitled “Account 12345678” is selected and displayed within the file view pane 830.

### Scheduling Periodic Saving and Indexing of Web Pages

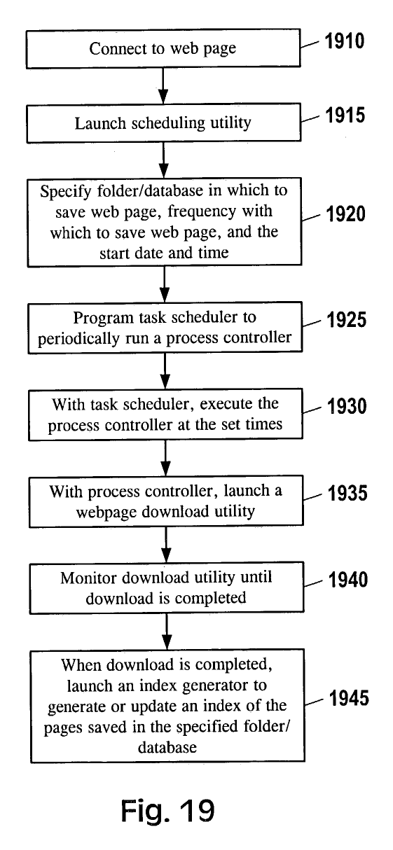

As noted above, FIG. 15-19 illustrate the scheduled save functionality and operability of the present invention. FIG. 15 is a block diagram of one embodiment of the scheduled save utility 235 of the information and capturing system 200, comprising an Internet gateway user interface 1510 (such as a web browser), an operating system task scheduler 1540, a utility 1520 operable to program the task scheduler 1540, a process controller 1530, a save utility 1560, and the index generating module 220. As explained further in connection with FIG. 19 below, the task scheduler 1540 is programmed to periodically launch the process controller 1530, which in turn launches the save utility 1560 and index generating module 220.

FIG. 19 is a functional flow chart of one embodiment of a method of periodically saving and indexing one or more web pages. In functional block 1910, the user connects to a web page. In functional block 1915, the user launches the scheduled save utility 235 of the information capturing and indexing system 200. In functional block 1920, the user specifies the folder or database in which to save the web page, the frequency with which to save that web page, and the date and time to start saving the connected web page. FIG. 16 depicts a dialog box 1600, described further below, with which the scheduled save utility 235 enables a user to specify this information.

In functional block 1925, the scheduled save utility 235 programs the operating system task scheduler 1540, such as the task scheduler commonly found on operating systems sold by Microsoft®, to periodically launch the process controller 1530. In functional block 1930, the task scheduler then executes the process controller at the specified times. Each time the process controller 1530 is executed, it launches, as shown in functional block 1935, the save utility 1560, which links to and downloads the specified web page. The save utility 1560 may be any program, module, or utility, including the web page save utility 240 or the web site index utility 245 described elsewhere herein, which is utilized by the information capturing and indexing system 200 to download and save a web page.

In functional block 1940, the process controller 1530 periodically polls the save utility 1560 to determine when the download has been completed. In essence, the process controller 1530 asks the save utility 1560, “Are you finished yet?” When the save utility 1560 has completed the download process, the process controller 1530 launches the index generating module 220 to generate or update an index of the pages saved in the specified folder.

FIG. 16 is a screen display of a scheduled save dialog box 1600 superimposed upon a browser view embodiment 300 of the GUI display module 215 of the information capturing and index system 200. The dialog box 1600 provides an address bar 1610 to specify the web page which should be periodically saved and indexed, a folder selection menu 1620 to specify a folder in which to save the specified web page, a frequency menu 1630 to specify the frequency with which to download and save the specified web page, a date selection menu 1640 to specify the starting date to commence the scheduled task, and a time dialer 1650 to specify the starting time to perform the saving and indexing task. The dialog box 1600 also provides a scheduled saved task list 1660 and a plurality of buttons 1670 for adding, removing, and editing tasks listed within the scheduled saved task list 1660.

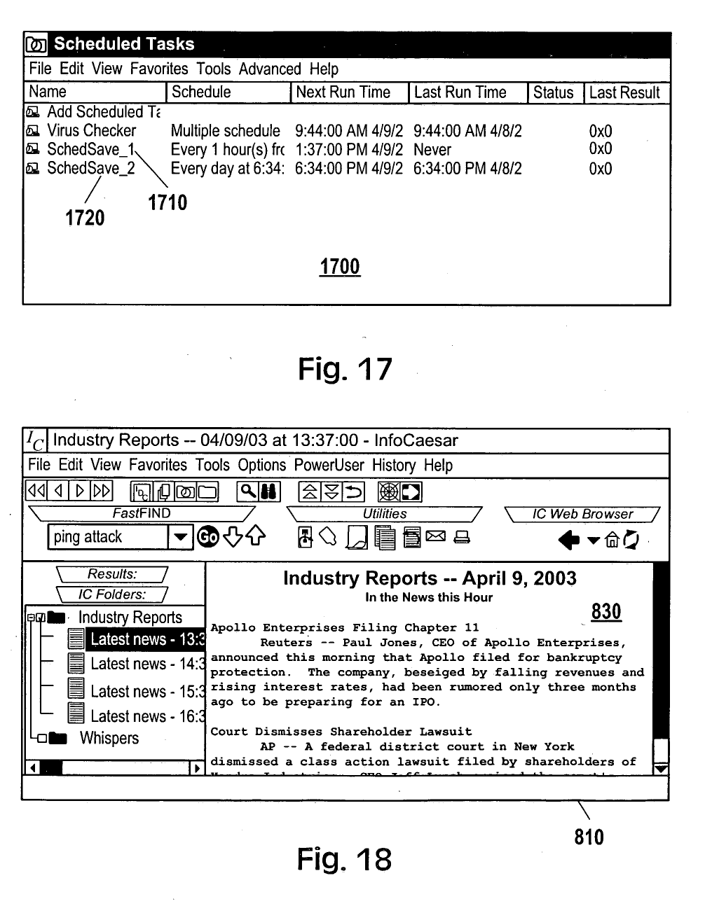

FIG. 17 is a screen display of a typical operating system task scheduler 1700 listing two exemplary tasks 1710 and 1720 corresponding to the tasks shown in the scheduled save task list 1660 of FIG. 16. FIG. 18 is a screen display of a folder view embodiment 810 of the GUI display module 215 of FIG. 2. In this figure, the file view pane 830 is depicted displaying the contents of the web page specified in the address bar 1610 of FIG. 16 as it appeared at one of the scheduled save times.

### Linked Web Page Capture

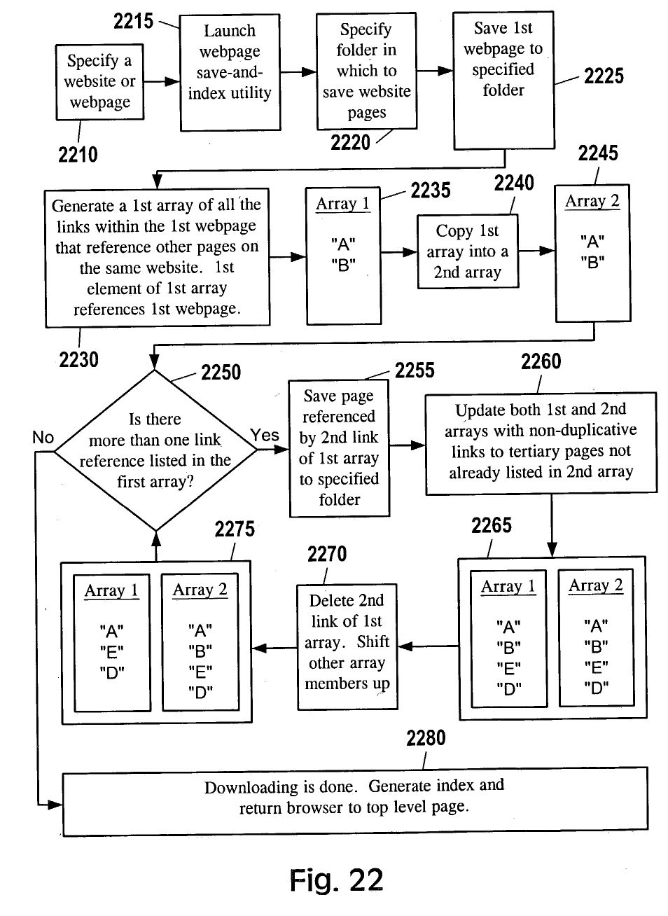

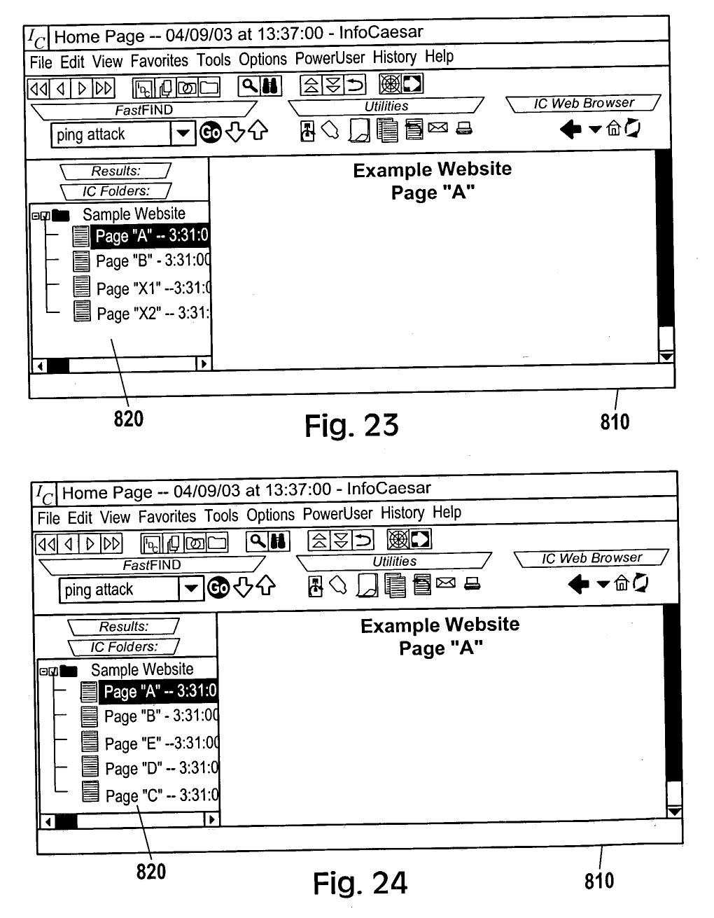

As noted above, FIG. 20-24 illustrate the web page saving and web site saving functionality and operability of the present invention. FIGS. 21 and 22 illustrate two methods of saving web pages and the application of those methods to the group of exemplary web pages illustrated in FIG. 20. FIGS. 23 and 24 further illustrate the application of the methods of FIGS. 21 and 22 to the group of exemplary web pages illustrated in FIG. 20.

FIG. 20 is a block diagram illustrating some linking relationships between a plurality of hypothetical web pages residing on and external to a web site. A first group 2010 of web pages 2020, 2030, 2040, 2050, and 2060 reside on a common domain or web site. These web pages 2020-2060 have various internal links with each other and various external links to web pages 2070, 2072, 2074, and 2076, which reside on other domains or web sites. For example, page “A” 2020 is depicted as having a link to page “B” 2030 and two links to external pages “X1” 2070 and “X2” 2072. Page “B” 2030 is depicted as having links to page “A” 2020, page “D” 2050, and page “E” 2060. Page “C” 2040 is depicted as having links to page “A” 2020, page “B” 2030,-and page “D” 2050. Page “D” 2050 is depicted as having links to page “C” 2040, page “E” 2060, and external page “X4” 2076. Page “E” 2060 is depicted as having links to page “D” 2050, external page “X3” 2074, and external page “X4” 2076.

FIG. 21 is a block diagram illustrating one embodiment of a method of saving a specified web page and all of the pages to which the specified web page provides a link. In functional block 2110, the specified web page is saved to a specified folder or database, and a complete list of links in the specified page is extracted to an array 2115. The first link in the array 2115, however, is reserved for the address of the specified web page itself.

More particularly, FIG. 21 illustrates the operation of functional block 2110 on the group 2010 of web pages illustrated in FIG. 20, with page “A” 2020 being the specified web page. The first element of array 2115 refers to page “A” 2020 itself. Because page “A” 2020 has links to pages “B” 2030, “X1” 2070, and “X2” 2072, the remaining elements of array 2115 likewise have references to these pages.

Processing of the array 2115 begins in functional block 2120. The page referenced by the second link in the array 2115 is saved and the second link is deleted from the array 2115. FIG. 21 illustrates the operation of functional block 2120 on array 2115 in the form of a modified array 2125 that does not include a link to page “B” 2030.

In functional block 2130, the process proceeds to the next link. The page referenced by the next link in the array 2115 or in the modified array 2125 (in this example, page “X1” 2070) is saved and the link is deleted from the array. FIG. 21 illustrates the operation of functional block 2130 on array 2125 in the form of a twice-modified array 2135 that does not include a link to page “X1” 2070.

In functional block 2140, the process proceeds to the next link. The page referenced by the next link in the array 2115 or in the twice-modified array 2135 (in this example, page “X2” 2072) is saved and the link is deleted from the array. FIG. 21 illustrates the operation of functional block 2140 on array 2135 in the form of a thrice-modified array 2145 that does not include a link to page “X2” 2072.

The process depicted in functional blocks 2120, 2130, and 2140, is repeated until the only link left in the array 2115 is the link to the originally specified web page (in this example, page “A” 2020). At this point, as depicted in functional block 2150, the downloading is complete. An index of all of the saved pages is generated and the browser is returned to the specified page referenced by the last remaining link in the array 2115.

FIG. 22 is a block diagram illustrating one embodiment of a method of saving a specified web page and all of the pages residing on the same domain or web site as the specified web page that can be accessed by traversing links originating from the specified web page. FIG. 22 also illustrates the operation of this method on the group 2010 of web pages illustrated in FIG. 20. Using page “A” 2020 as the specified (i.e., “initial”) web page, the method will save pages “A” 2020, “B” 2030, “C” 2040, “D” 2050, and “E” 2060 to a specified index or database.

In functional block 2210, an initial page is specified. In functional block 2215, the web site save utility 245 of the information capturing and indexing system 200 is launched. In functional block 2220, a folder or database in which to save the pages is specified. In functional block 2225, the web site save utility 245 saves the initial page into a specified folder or database.

In functional block 2230, the web site save utility 245 generates a first array of all of the links within the initial page that reference other pages on the same domain. The first element of the array, however, is reserved as a reference to the initial page. FIG. 22 illustrates a first array 2235 that is created by the operation of functional block 2230 on the group 2010 of web pages illustrated in FIG. 20, with page “A” 2020 being the initial page. The first array 2235 is shown having references to page “A” 2020 and Page “B” 2030. In functional block 2240, the first array 2235 is copied into a second array 2245. At this point, the second array 2245 is an exact copy of the first array 2235.

The process then proceeds to a conditional loop. In conditional block 2250, the web site save utility 245 evaluates the first array. If there is more then one link reference listed in the first array 2235, then in functional block 2255, the page referenced by the second link of the first array is saved to the folder specified by functional block 2220. In functional block 2260, the web site save utility 245 examines the links in the page referenced by the second link of the first array and adds to both the first and second arrays any links to pages on the same domain or web site as the initial page that are not already listed in the second array 2245. The first iteration of the operation of functional blocks 2255 and 2260 on the first array 2235 and second array 2245 is illustrated in block 2265, which shows both arrays modified to include links to pages “E” 2060 and “D” 2050.

In functional block 2270, the second link of the first array 2235 is deleted and the other array members are shifted up. The second link of the second array 2245, by contrast, is not deleted, because it functions as a master list or array of all the pages referenced by the method of FIG. 22, whether or not they have been saved by the method of FIG. 22. The first array 2235 functions as a working array of pages yet to be saved by the method of FIG. 22. The first iteration of the operation of functional block 2270 on the first array 2235 and second array 2245 is illustrated in block 2275, which shows the first array 2235, but not the second array 2245, modified to exclude a link to the just-saved page “B” 2030.

The operation of functional loop comprising conditional and functional blocks block 2250, 2255, 2260, and 2270 are repeated until there is only one link reference left in the first array 2235. At this point, the downloading is complete. Next, as depicted in functional block 2280, the index-generating module 220 generates an index of all of the saved pages. Finally, the browser, which had displayed the initial web page specified in functional block 2210, is returned to the initial web page.

An alternative to the two-array system and method of FIG. 22 is to substitute the first array with a pointer to the second array. To keep track of the pages that have already been saved, the pointer would initially point to the first element of the array. Then, as pages were saved, it would be incremented to the next element in the array. In this alternative (not shown in the drawings), conditional block 2250 would read “is the pointer pointing to the last non-blank element of the array?” If so, the process would proceed to block 2280. If not, the process would proceed to functional block 2255, which would be changed to “increment the pointer and, after the pointer has been incremented, save the page referenced by the pointer.” Functional block 2270 would be deleted.

FIG. 23 is a screen display of a folder view embodiment 810 of the GUI display module 215 of FIG. 2 showing a folder pane 820 listing the pages saved by performing the method of FIG. 21 on the specified page “A” 2020 of FIG. 20. As shown in FIG. 23, folder pane 820 lists pages “A” 2020, “B” 2030, “X1” 2070, and “X2” 2072—all of the pages to which specified page “A” 2020 provides a link.

FIG. 24 is a screen display of a folder view embodiment 810 of the GUI display module 215 of FIG. 2 showing a folder pane 820 that lists the pages saved by performing the method of FIG. 22 on the specified page “A” 2020 of FIG. 20. As shown in FIG. 23, folder pane 820 lists pages “A” 2020, “B” 2030, “C” 2040, “D” 2050, and “E” 2060—all of the pages on the domain or web site 2010 which can be accessed by traversing the links originating on specified page “A” 2020.

### Document Authentication System

FIG. 25 illustrates one embodiment of an authentication utility or module 225 of the information capturing and indexing system 200 of FIG. 2. The utility or module 225 is operable to add one or more authentication codes 2590, 2545 to a file. In this figure, a 1000-byte file 2510 is used for illustration purposes, even though the utility 225 is operable on files of almost any finite size. In this exemplary embodiment, a first authentication code 2590 is generated using a cryptographic transformation function of the content of the file 2510 itself and a second authentication code 2545 is derived from the time and date 2520 at which the file 2510 is expected to be saved or indexed. It will be understood, of course, that the present invention is intended to cover systems or methods that provide only one of the two authentication codes 2590 and 2545, or systems or methods that combine authentication codes 2545 and 2590 into one. It will also be understood that other file attributes or file history information may be added to either authentication code 2590 or 2545.

The content of the file 2510 is preferably cryptographically transformed using a strongly collision-free hash function that produces a message digest of the file 2510. Those of ordinary skill in the art will appreciate that a strongly collision-free hash function H is one for which it is very improbable, if not computationally infeasible, to find any two different messages x and y such that H(x)=H(y).

A preferred strongly collision-free hash function renders the file 2510 as a 1000-row by 8-column binary matrix 2550. The binary digits of each column c in the matrix 2550 are summed, as illustrated by formulaic representations 2560 and by the more abstractly represented formula below:

Sⱼ=Σᵢ₌₀^{f-1}cⱼrᵢ

where Sⱼ is the sum of the binary digits in column j of matrix 2550, and where f equals the file size, in bytes, of the file 2510. Each columnar sum Sⱼ is then weighted by an integer multiplier mⱼ, and then each weighted columnar sum Sⱼ •mⱼ is added together to produce a message digest or weighted bit sum total 2570, the formula for which is more abstractly represented below:

Message Digest=Σⱼ₌₀⁷(Mⱼ)(Sⱼ)=Σⱼ₌₀⁷(Mⱼ)(Σᵢ₌₀^{f-1}Cⱼrᵢ)

Preferably, each columnar sum Sⱼ has a unique multiplier mⱼ. For example, the column c₀ (matrix 2550) may have a multiplier of 1, column c₁ a multiplier of 2, column cl a multiplier of 4, and so on. Alternatively, each multiplier may be a unique prime number or any other number not used for another column multiplier.

Next, the message digest 2570 is converted to a basex content code 2580, which is then embedded into an authentication code 2590, along with other information and other decoy bits, characters, or digits (shown in connection with reference number 2590 with cross hatching) that may optionally be interspersed with the content code 2580. Those of ordinary skill in the art will, of course, appreciate that other strongly collision-free cryptographic functions could be used instead of the hash routine described herein.

To generate the time-stamp authentication code 2545, the information capturing and indexing system 200 (FIG. 2) determines the approximate date and time 2520 during which a file is to be saved to or indexed within a database folder. The date and time 2520 may be obtained from the operating system 150 (FIG. 1), the basic input/output system (BIOS) (not shown) of the computer 120 (FIG. 1), or from an application or a trusted external source (such as one of the time servers operated by the United States' National Institute of Standards and Technology) that provides accurate date and time information.

Next, a “hard to invert” cryptographic transformation function 2530 takes the date and time 2520 as an input to generate a cryptographic time stamp 2540. Those of ordinary skill in the art will understand that a cryptographic function H is considered “hard to invert” if for a given cryptographic value h, it is computationally infeasible to find some input x such that H(x)=h. Next, the time stamp 2540 is embedded into the authentication code 2545, along with other information and other decoy bits, characters, or digits (shown in connection with reference number 2545 with cross hatching) that may optionally be interspersed with time stamp code 2540.

One example of “other information” that may be incorporated into the authentication code 2545 or 2590 is a flag indicating whether the file was edited prior to being saved. One embodiment of the information capturing and indexing system 200 permits a user to edit a file after it is retrieved from an external source (such as the Internet) but before it is saved to a folder and indexed to a database. In this embodiment, a software module (not shown) is used to track any changes made to a file after it has been retrieved from another source for display in GUI display module 215. This information is optionally incorporated and encrypted into the authentication code 2545 or 2590, to enable the system 200 to keep track of whether a file was changed after it was retrieved but before it was saved.

Both the content code 2580 and the time stamp 2540 are preferably produced using cryptographic transformation functions that produce fixed-length outputs. Alternatively, functions that produce variable-length outputs may be used, provided that delimiters or length-signaling characters are placed in the authentication code 2590, 2545.

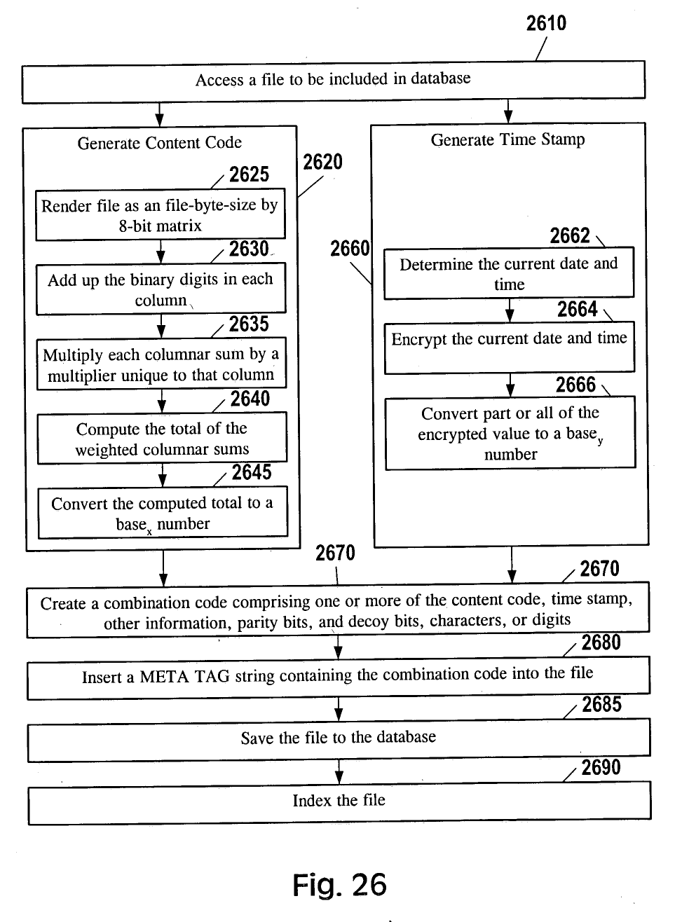

FIG. 26 is a functional block diagram of a method of adding authentication information to a file. In functional block 2610, the database and file selection module 210 or the GUI display module 215 in the browser mode 300 is used to access a file intended to be included within the database. FIG. 26 illustrates method steps for adding two different types of authentication information into one or more authentication codes. It will of course be understood that the method in FIG. 26 can be adapted to incorporate only one of these two types of authentication information. Block 2620 depicts functions that generate authentication information pertaining to the content of the file. Block 2660 depicts functions that generate authentication information derived from the date and time a file was downloaded from the Internet or transferred from another source, or the approximate date and time that the authentication utility 225 expects the file to be saved or indexed.

The process for generating content-related authentication information begins with functional block 2625, in which a given file is rendered as a file-byte-size by 8-bit matrix. In functional block 2630, the binary digits of each column of the matrix are added up. In functional block 2635, a weighted columnar sum is computed by taking the product of each columnar sum with a unique multiplier for that column. In functional block 2640, a message digest is generated equal to the sum of the weighted columnar sums. In functional block 2645, this message digest is converted into a number system with a different base or radix, preferably an unfamiliar or unusual number system with a large radix, the digits of which may be represented by a subset of ASCII (American Standard Code for Information Interchange) characters. The new radix (which may be a prime number) is preferably an odd number or a number that does not share any whole number factors or whole number divisors (other than 1) with the original radix.

The process for generating a time stamp starts with functional block 2662, where the date and time are ascertained. In functional block 2664, the date and time are provided as inputs to a cryptographic transformation function. As was done with the content-related authentication component, in functional block 2666, the output of the cryptographic transformation function, or portions thereof, are optionally converted to a different number base.

In functional block 2670, one or more combination codes are generated that comprise one or more of the baseₓ transformed message digest, the time stamp, parity bits, delimiters, other information, and optional decoy bits, characters, or digits. In functional block 2680, one or more Meta tag strings (e.g., one Meta tag string for the content code, and another Meta tag string for the time stamp) containing the one or more combination codes are inserted into the file. In functional block 2685, the file is saved to the database, and in functional block 2690, the file is then indexed.

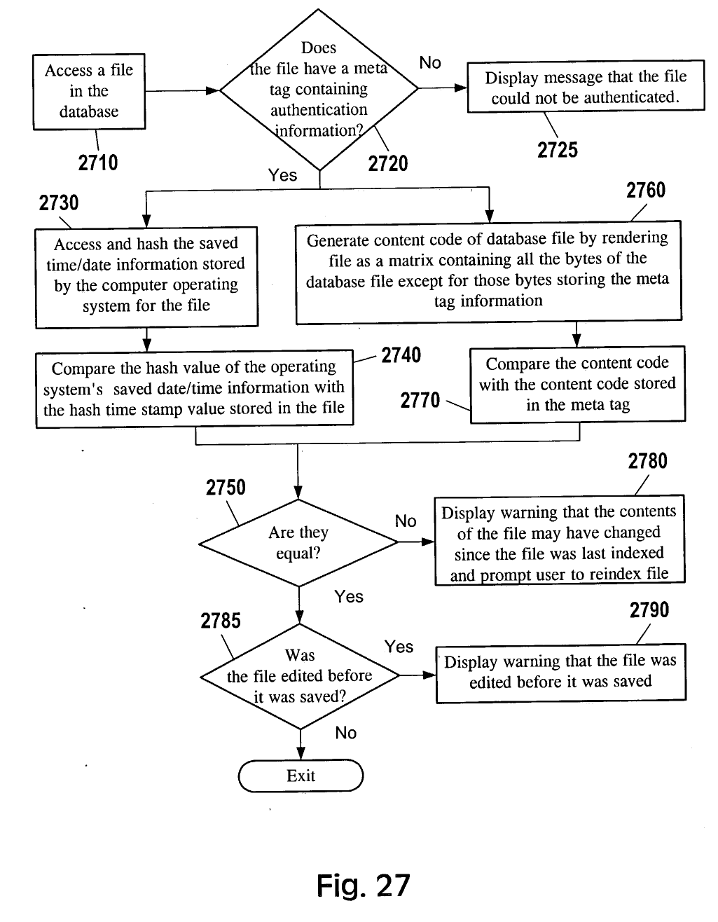

FIG. 27 is a functional flow diagram of a method of authenticating an indexed file. In functional block 2710, the database and file selection module 210 accesses a file in the database 160 (FIG. 1). In conditional block 2720, the authentication utility or module 225 evaluates the file.

If the file has a Meta tag string containing encoded time stamp information, then in functional block 2730 the database and file selection module 210 accesses and encrypts the saved time and date information stored by the computer operating system 150 for the saved file. Encryption is performed using the same cryptographic transformation function that the file selection module 210 would use to generate a time stamp for insertion into a Meta tag string. In functional block 2740, this value is compared with the encrypted time stamp value stored in the Meta tag string of the file. If in conditional block 2750 these two encrypted values are not equal, then in functional block 2780, the database and file selection module 210 displays a warning that the contents of the file may have changed since file was last indexed. Additionally, the database and file selection module 210 prompts the user to choose whether or not to re-index the file. FIG. 29 illustrates a dialog box 2910 containing this warning.

Alternatively or in addition, if the file has a Meta tag string containing content code information, then in functional block 2760, the database and file selection module 210 generates a content code of the saved file using the process depicted in FIG. 25 or 26, except that it excludes from the matrix 2550 those bytes representing the Meta tag string. In functional block 2770, this freshly generated content code is compared with the content code 2580 stored in the Meta tag string. If they are not equal, then in functional block 2780, the database and file selection module 210 displays a warning that the contents of the file may have changed since the file was last indexed. Furthermore, the database file and selection module 210 prompts the user to choose whether or not to re-index the file.

If the file has passed all applicable authentication tests (see conditions 2720, 2750), then in conditional block 2785, information is retrieved from the meta tag indicating whether the file was edited before being saved. If so, in functional block 2790, the database and file selection module 210 displays a warning that the file was edited prior to being saved.

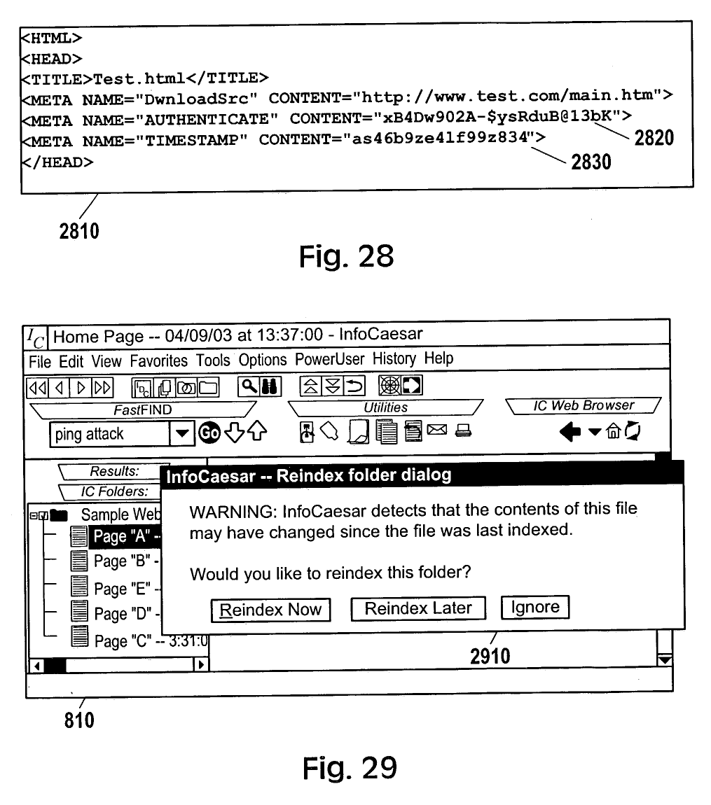

FIG. 28 illustrates a portion of the HTML code of an exemplary web page containing a content-code authentication meta tag 2820 and a time-stamp meta tag 2830. FIG. 29 is a screen display of a dialog box 2910 presenting the warning described in functional block 2780 (FIG. 27). The dialog box 2910 is shown superimposed on the folder view embodiment 810 of the GUI display module 215 of the information capturing and indexing system 200.

Persons of ordinary skill in the art, enlightened by the present specification and those incorporated by reference, will understand how to build a system or write software code capable of carrying out the inventive concepts disclosed herein.

Although the foregoing specific details describe a preferred embodiment of this invention, persons reasonably skilled in the art will recognize that various changes may be made in the details of the method and apparatus of this invention without departing from the spirit and scope of the invention as defined in the appended claims. Therefore, it should be understood that, unless otherwise specified, this invention is not to be limited to the specific details shown and described herein.

We claim:

1. An information capturing system for retrieving financial transaction information, the system comprising:
a browser module operable to link to a web page containing an account transaction history web page, the account transaction history web page having a first set of links to processed financial transaction document images, and a second set of links to an assortment of other objects; and
a financial transaction image capture module operatively linked to the browser module, the image capture module being operable to evaluate the account transaction history web page, distinguish the first set of links from the second set of links, and automatically download the processed financial transaction document images without downloading the assortment of other objects.

2. The information capturing system of claim 1, wherein the processed financial transaction documents include cancelled checks.

3. The information capturing system of claim 1, further comprising a dialog box operable to enable a user to identify a folder into which the financial transaction image capture module saves the processed financial transaction documents images.

4. The information capturing system of claim 1, further comprising an index generating module operable to generate a searchable index of the account transaction history web page and the processed financial transaction documents images.

5. The information capturing system of claim 4, further comprising a dialog box operable to enable a user to specify a folder into which the financial transaction image capture module is to save the processed financial transaction documents images.

6. The information capturing system of claim 5, further comprising a database and file selection module operable to display the specified folder and any contents that have been saved to the specified folder.

7. A method for retrieving financial transaction information, the method comprising:
accessing a web page containing an account transaction history web page, the account transaction history web page having a first set of links to processed financial transaction document images, and a second set of links to an assortment of other objects;
automatically distinguishing the first set of links from the second set of links; and
automatically downloading the processed financial transaction document images without downloading the assortment of other objects.

8. The method of claim 7, further comprising specifying a folder in which to download the processed financial transaction document images.

9. The method of claim 8, further comprising saving the processed financial transaction document images into the specified folder.

10. The method of claim 9, further comprising downloading the account transaction history web page.

11. The method of claim 10, further comprising modifying the first set of links in the downloaded account transaction history web page to link to the saved processed financial transaction document images.

12. The method of claim 11, further comprising saving the downloaded account transaction history web page into the specified folder.

13. The method of claim 12, further comprising generating a searchable index of the contents of the specified folder.

14. The method of claim 12, further comprising updating a searchable index of the contents of the specified folder.

15. The method of claim 7, further comprising generating a searchable index of the downloaded processed financial transaction document images.

16. The method of claim 7, further comprising updating a searchable index of the downloaded processed financial transaction document images.

17. An information capturing system for retrieving financial transaction information, the system comprising:
means for linking to a web page containing an account transaction history web page, the account transaction history web page having a first set of links to processed financial transaction document images, and a second set of links to an assortment of other objects; and
means for automatically evaluating the account transaction history web page, distinguishing the first set of links from the second set of links, and downloading the processed financial transaction document images without downloading the assortment of other objects.

18. The information capturing system of claim 17, further comprising indexing means for generating a searchable index of the account transaction history web page and the processed financial transaction documents images.

19. The information capturing system of claim 18, further comprising means for enable a user to specify a folder into which the processed financial transaction documents images are to be saved.

20. The information capturing system of claim 19, further comprising means for displaying the contents of the specified folder.
